(19) United States
(12) Patent Application Publication
(10) Pub. No.: US 2006/0127732 A1
(43) Pub. Date: Jun. 15, 2006

(54) Fuel cell stacking method and fuel cell tracking device

(76) Inventors: Tadashi Yoshida, Hitachi (JP); Daisuke Harada, Chigasaki (JP); Shoji Nakakuki, Hitachi (JP); Masumi Ikeda, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/296,292

(22) Filed: Dec. 8, 2005

(30) Foreign Application Priority Data
Dec. 10, 2004 (JP) 2004-358111

(51) Int. Cl. H01M 8/00; H01M 8/24

(52) U.S. Cl. 429/34; 429/12; 29/623.1; 429/32

(57) ABSTRACT

It is intended to efficiently accomplish stacking of members of high molecular electrolytic type fuel cells. The invention discloses a fuel cell stacking device for conveying stack members to constitute a fuel cell stack and stacking them in a prescribed sequence, comprising a conveying robot, a stacking robot, a guide rail for enabling each robot to move to the stacking position along a prescribed route, a unit for detecting sides and/or apexes of the stack members, and a unit for aligning the positions of the stack members on the basis of the detected information. The invention also discloses a relevant fuel cell stacking method.

### CLAIM OF PRIORITY

This application claims priority from Japanese application serial no. 2004-358111, filed on Dec. 10, 2004, the content of which is hereby incorporated by reference into this application.

### FIELD OF THE INVENTION

The present invention relates to a fuel cell stacking method and a fuel cell stacking device for stacking fuel cells.

### BACKGROUND OF THE INVENTION

A fuel cell stack is a structure composed by stacking a plurality of cells each consisting of a separator, an electrolyte membrane, an electrode assembly or a membrane electrode assembly (MEA), a gas diffusion layer and a gasket, and fitting to their ends terminal plates including a current collector plate, an insulator plate and a terminal holding plate. Although these parts are stacked by manual work at the developmental stage, once the specifications of the stack are fixed to enter into a mass production stage, an automatic stacking device becomes necessary.

Among the parts to be stacked, the separator and end parts are relatively thick and close to rigid bodies, the MEA and the gasket are made of soft thin films and, moreover, covered with protective sheets to protect their surfaces until immediately before stacking. The diffusion layer, differing from other parts in external dimensions, has to be accurately stacked over the electrode portion of the MEA.

When these parts are to be stacked by hand, the assembling method that is used is to first stack them in their approximate positions, finely adjusting their positioning with tweezers or the like, and pressing a guide rail against them sideways at intervals of a few cells to align the parts perpendicularly. Aligning them perpendicularly is synonymous to correcting intricate positional deviations of the parts.

On the other hand, there also is a case, as described in Patent Document 1, wherein projections and holes are provided in the separator and other parts to structure them to be free from positional deviation. In a mass production process, a device is needed to automatically stack these parts differing in properties with high accuracy. Although Patent Document 1 discloses a method of assembling solid high molecular electrolytic type fuel cells, but not their mass production method or a device for that purpose.

[Patent Document 1] Japanese Patent No. 3427915

Realization of an automatic stack system to handle both thick and heavy parts including the separator and thin film light parts including the MEA, realization of a function to peel off the protective sheets covering the MEA and others, and realization of an automatic stacking system accurately, efficiently and without damaging these parts is of vital importance to the mass production of fuel cell stacks.

A fuel cell stack is composed of thin and light parts such as the MEA, diffusion layer and gasket and thick and heavy parts such as the separator and terminal plates, and these parts are diverse in size. A challenge to be met is to work out a system to handle all of them and, as some of the parts have to be cleared of their protective sheets immediately before stacking, another challenge is to develop a pre-stacking treatment method. Still another challenge is to devise a system to stack these diverse parts with high accuracy.

An object of the present invention is to provide a stacking method and a stacking device suitable for mass production of high molecular electrolytic type fuel cell stacks.

### SUMMARY OF THE INVENTION

The present invention provides a fuel cell stacking method for conveying stack members to constitute a fuel cell stack and stacking them in a prescribed sequence, comprising the steps of: moving each stack member to the prescribed stacking position thereof with a conveying robot; detecting the positions or shapes, for instance sides and/or apexes, of the stack members; aligning the positions of the stack members on the basis of the detected information; stacking the stack members with a stacking robot in a prescribed sequence; and fixing the stacked stack members.

The invention further provides a fuel cell stacking device for conveying stack members to constitute a fuel cell stack and stacking them in a prescribed sequence, comprising a conveying robot, a stacking robot, a guide rail for enabling each robot to move to the stacking position along a prescribed route, a unit for detecting the positions or shapes of the stack members, and a unit for aligning the positions of the stack members on the basis of the detected information.

According to the invention, it is possible to detect the positions or shapes of stack members and efficiently stack members of fuel cells by utilizing a conveying robot and a stacking robot, and thereby contribute to mass production of fuel cell stacks. In particular according to the invention, it is also possible to automate the stacking of fuel cell stacks.

### BRIEF DESCRIPTION OF THE DRAWINGS

FIG. 1 illustrates the overall configuration of a device according to the present invention.

FIG. 2 illustrates the configuration of a parts handling unit.

FIGS. 3A to 3D illustrate the configuration and actions of a gasket protective sheet peeling mechanism.

FIGS. 4A and 4B illustrate the configuration and actions of an MEA protective sheet peeling mechanism.

FIG. 5 illustrates the configuration of a fuel cell stack according to the invention.

FIG. 6 is a schematic profile illustrating the stacking state of the fuel cell stack according to the invention.

FIG. 7 is a schematic plan illustrating a stacking method for the fuel cell stack according to the invention.

### DETAILED DESCRIPTION OF THE PREFERRED EMBODIMENT

A fuel cell stacking device for automatically stacking fuel cell stacks each consisting of a variety of parts is required to be compatible with the handling of those many different parts, to perform pre-stacking treatment matching the characteristics of each part and accurately adjust the stacking position. The handling mechanism can be compatible with diverse parts by handling thin and light parts with an electrostatic chuck system and thick and heavy parts with a suction chuck system. It can be adapted to different sizes of parts by doubly structuring the chuck units.

As the mechanism to peel off protective sheets, parts provided with warp prevention margins are used with highly repulsive protective sheets, and an end cutting system is used with less repulsive protective sheets. In order to accurately stack these parts differing in thickness and other dimensions, a system of optically detecting two apexes of each part is used.

The stacking device according to the invention has a supply zone comprising an area for supplying a small-number stack members and an area for supplying a large-number stack members, a stacking zone for stacking stack members, and a protective sheet peeling zone and a dust removing zone disposed between the supply zone and the stacking zone.

The stack members are divided into the large-number members and the small-number members, and can be accommodated into a tray for the large-number members and a tray for the small-number members, respectively. It is preferable for the handling unit of the conveying robot to have a handling subunit for lighter members and a handling subunit for heavier members, or to be replaceable.

The fuel cell stack may have a plurality of stacking device conveying robots and stacking robots. It is desirable for a member handling unit to have a small member handling subunit and a large member handling subunit or the handling unit to be replaceable with another unit having a required function.

It is further desirable for the fuel cell stacking device to have a mechanism for peeling off the protective sheets of stack members. It is desirable for the peeling mechanism to be equipped with a sub-mechanism or sub-mechanisms in one or more corners of each stack member, a sub-mechanism for cutting only an equivalent of the thickness of the protective sheet, a sub-mechanism for cutting only an equivalent of the thickness of a protective sheet on one side and double the thickness of the member itself, or a sub-mechanism for cutting only an equivalent of the thickness of the member itself. The peeling mechanism for protective sheets is disposed between the conveyance area and a stacking area.

It is preferable, with a view to preventing electrodes from being damaged or smeared, for the fuel cell stacking device to be provided with a mechanism which does not come into contact with the electrode portion of the MEA but chucks the electrolyte membrane around the electrode portion.

It is desirable for the fuel cell stacking device to be equipped with a dust removing unit for stack members between the conveyance area and the stacking area. It is desirable for dust to be removed from both upper and lower faces of each member either at the same time or separately. The dust removing mechanism can use blowing of gas, suction or electrostatic force.

It is desirable for members to be positioned for stacking by the stacking robot, for means to be provided for detecting the position of each member after it is stacked. As the device for the positioning of members for stacking and the detection of the position of each member after it is stacked, a laser system or an image sensing system can be used.

It is desirable for the inside of the hardware of the fuel cell stacking device to be a closed space to fill the closed space with dusted gas. It is preferable to provide a mechanism which can make the inside of the hardware a closed space and adjust the humidity and temperature of the gas in that space.

The conveying robot and/or the stacking robot can be equipped with mechanisms or a mechanism for adjusting the degree of acceleration/deceleration according to the length of the stroke of member shifting. It is desirable to provide stoppers or a stopper to prevent the members or member from straying in the shifting strokes or stroke of the conveying robot and/or the stacking robot.

Each robot arm is provided with a separate handling mechanism to enable the arm to handle both thick and heavy parts and thin film light parts. The suction chuck is used as the mechanism for handling thick and heavy parts, and the electrostatic chuck is used as the mechanism for handling thin film light parts.

Thin film parts having protective sheets include the MEA and the gasket. Though differing with the specifications of the part and with the manufacturer, the MEA is covered with protective sheets on both sides, while the gasket often has a protective sheet on only one side. The protective sheets of the MEA are not only thin, a few tens of μm in thickness, but also soft, the protective sheet of the gasket is not only thick, about 100 μm, but also highly repulsive. Therefore, they have to be handled with different mechanisms.

Where an MEA covered with thin and soft protective sheets on both sides, when one of its three-layered end is cut in a two-layer thickness and the three-layered end is pinched and pulled off, the protective sheet on one side is peeled off. After that, when another end is cut in a one-layer thickness and a two-layered end is pinched and pulled off, the MEA remains.

For a gasket provided with a thick and hard protective sheet on one side, a pinching margin is disposed a few mm beyond the size for use, a cut is made in advance into the gasket between the pinching margin and the real size and no cut is made into the protective sheet. When the pinching margin is pinched and the protective sheet is pulled off with the gasket being fixed with the electrostatic chuck, the protective sheet will come off the gasket.

In stacking the parts, an optical system is easier to use for accurate planar positioning. A laser system or an image sensing system can be used. In order to determining the planar position of a part, it is sufficient to detect the positions of two corners as shown in FIG. 7. They may be two ends of a side or on a diagonal, or the positions of two sides may be detected as well. Where a corner is rounded or chamfered, the position of the corner point is in the space outside the part. To optically detect the position of such a point, the positions of the two sides crossing at that point can be figured out and the position of that intersection can be calculated on that basis. It is possible to secure accuracy with a tolerance of 1/100 mm to 5/100 mm, a sufficiently high level for the stacking of fuel cells.

According to the invention, an electrostatic chuck is used for the handling of thin and light parts and an air suction chuck for thick and heavy parts. Separate mechanisms are provided for the conveyance of parts and the stacking of parts. The protective sheet, if any, covering a stack part is peeled off with a mechanism matched with the structure of that part, and stacking positioning is performed by optically detecting two apexes of the part. Accuracy checkup of the stacked position is also carried out optically, with clean air delivered into the whole inside of the device, whose temperature and humidity are controlled, and each individual part being dusted. By providing the fuel cell stacking device with an accelerating/decelerating mechanism to accomplish conveyance and stacking and another mechanism to prevent deviation during conveyance, fuel cells can be automatically stacked with high efficiency and accuracy.

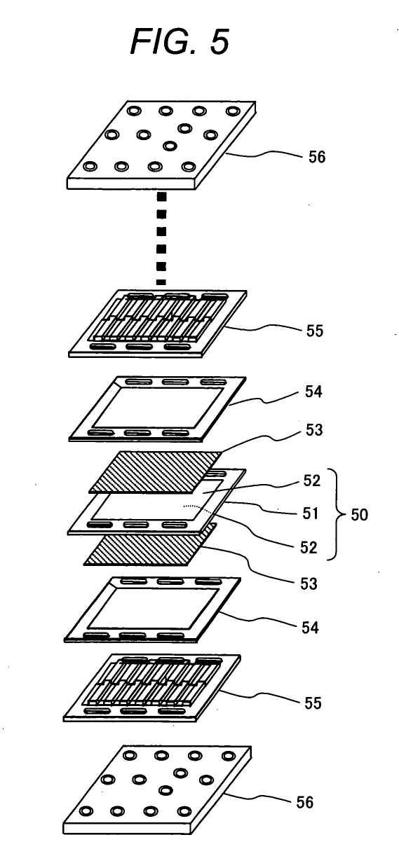

Next will be described the configuration of the fuel cell stack. FIG. 5 illustrates the basic configuration of the fuel cell stack. An MEA 50 is a portion where electric power generating reaction is caused to take place. The MEA 50 comprises electrodes 52 stuck to and integrated with the two sides of an electrolyte membrane 51, which constitutes the substrate. On one side of each electrode, hydrogen gas, which serves as the fuel is made to flow and on the other side, air which serves as the oxidizer is made to flow. In order to diffuse the gas more readily to the electrodes 52, diffusion layers 53 of about the same size as the electrodes 52 are so stacked as to cover the electrodes.

To seal the gas, gaskets 54 are so stacked as to cover the exposed parts of the electrolyte membrane 51 of the MEA 50. The diffusion layers 53 are thereby arranged in the bored parts of the gaskets 54. Further to form gas channels, separators 55 are stacked. This stacking sequence is repeated and, finally, terminal plates 56 are installed at both ends, and the whole assembly is fastened to finish the fuel cell stack.

Next will be described a mode in which the invention is implemented. As the forms of handling units, an electrostatic chuck is used for thin and light parts and a suction chuck, for thick and heavy parts.

As mechanisms for conveyance and stacking, arm-equipped robots are used. As the robot for conveyance use, a robot having long rails is provided so as to make possible collection of many different parts arranged in a extensive range, and as the for stacking use, a robot permitting highly precise control with a small operating range is provided so as to enhance the accuracy of stacking.

For each part covered with a protective sheet, a protective sheet peeling mechanism matching the structure of that part is provided.

In order to properly keep the conditions of the parts, the whole side of the stacking device is made a closed space, with clean air delivered into the whole inside of the device, whose temperature and humidity are controlled, and each individual part being dusted immediately before stacking.

In the positioning process before stacking, two apexes or the like of each part are optically detected, and the accuracy checkup after stacking is also optically accomplished by detecting the end positions in both perpendicular and horizontal directions. By combining these mechanisms, highly efficient and accurate automation of fuel cell stacking is achieved.

### Embodiment 1

Before describing the fuel cell stacking device according to the invention, the stacked structure of fuel cells will be described. FIG. 5 shows a developed view of constituent elements of a high molecular electrolytic type fuel cell, wherein the basic configuration of the unit cell is a repetitions of the sequence of the terminal plates 56 (usually made of metal), the separators 55, the gaskets 54, the gas diffusion layers 53, the electrodes 52 and the high molecular electrolyte 51. Incidentally, the high molecular electrolyte 51 and the electrodes 52 in contact with its two faces are usually integrated and used by the name of a membrane electrode assembly (MEA).

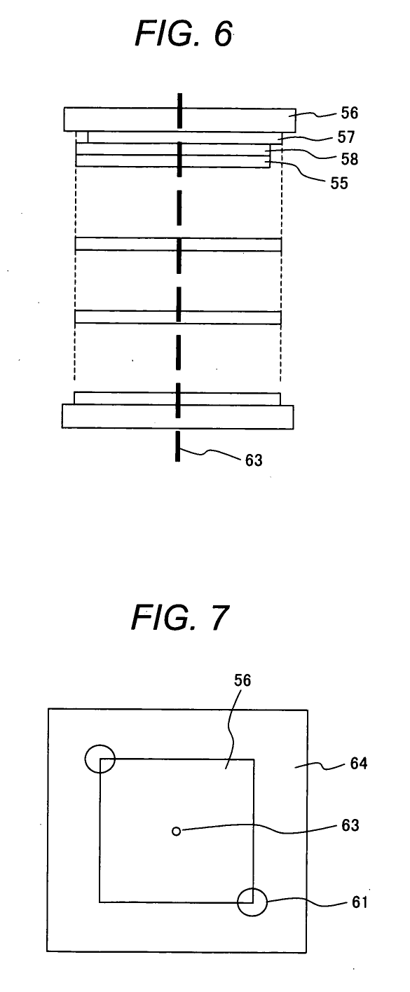

In an actual fuel cell stack, as shown in FIG. 6, an insulator plate 57 made of Teflon™ or the like and a highly electroconductive, for instance metal-made, current collector plate 58 are arranged adjacent to the terminal plates 56 and the separator 55, respectively, outside the stacked body consisting of stack members as shown in FIG. 5, and further a temperature measuring cell 62 having built-in thermometric means such as a thermocouple is arranged at intervals of tens of cells. Although the upper part of the stack configuration is shown in FIG. 6 for the convenience of illustration, in actual assembly of the stack various cell elements are stacked over the bottom terminal plate. The assembled stack is integrated and fixed together with the terminal plates with insulator pins or the like. In this way a fuel cell stack having tens of, for instance 80, stacked units is composed.

FIG. 7 shows a plan of the terminal plate 56. In assembling work with the stacking device, constituent elements are successively mounted on an assembling table 64 for instance and stacked. In that process, corner parts 61 of the terminal plates 56 and other constituent elements are optically detected, and the parts are so stacked as to align them with a preset center point 63 of the stacked cell. As a result, the terminal parts of the constituent elements may be out of alignment with one another as shown exaggeratedly in FIG. 6. However, since the center point 60 of the stacked cell is predetermined and the parts are stacked with reference to it, priority is given to align the stack element with this center point.

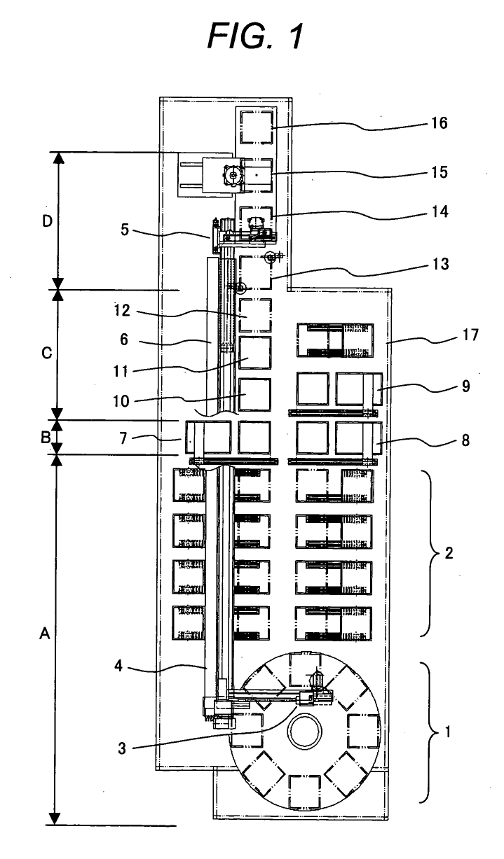

FIG. 1 shows a preferred embodiment of the present invention. Referring to FIG. 1, the cell stacking device, which is the preferred embodiment of the invention, comprises a conveyance zone A having trays 1 for a small-number members and trays 2 for large-number members, a protective sheet peeling zone B having protective sheet peeling units 7 and 8, a dust removing zone C and a stacking zone D. The configuration of this embodiment will be described with reference to FIG. 1. A fuel cell stack has many different kinds of parts, and the number of parts widely varies from one kind to another. To cope with this diversity, separate parts accommodating trays are disposed for different kinds. Further, trays for terminal plates and other parts whose number is small per kind and trays for parts whose number is large per kind are separately structured. In this embodiment, what belong to the small-number members are the terminal plates 56, the insulator plate 57, the current collector plate 58 and the temperature measuring cell 62, and the other parts belong to the large-number members.

It is preferable for the trays 1 for small-number members, because they need not be very deep, to be of a turntable type to reduce the required motions of the conveying robot and thereby enhance the efficiency of work. The position where the conveying robot picks up parts is fixed, and the tray whose load is up for stacking is turned to the position of pickup by the conveying robot.

On the other hand, the trays for large-number members, which need to be deeper, is equipped with a bottom lifting mechanism to reduce the workload of the conveying robot. When the upper most part is picked up, a plate at the bottom of the tray rises by the thickness of one part. To keep constant the height of the pickup position, the position of the upper end of each part is sensed, and the bottom plate is raised until the part rises to that position. This combination of trays for the large-number members and trays for the small-number members eliminates waste in the conveyance of members, which is thereby enabled to be increased in speed.

The conveying robot 3 has a guide rail, namely a conveying robot guide rail 4 to cover all the parts trays and protective sheet peeling units and a dust removing unit to be described afterwards.

Parts with no protective sheet, namely the separator, the diffusion layer and the terminal plates are conveyed by the conveying robot 3 to apart's upper side dusting unit 10. There, the conveying robot 3 temporarily frees the part to enable its upper side to be cleared of dust by electrostatic dusting, blowing or otherwise. After that, the conveying robot 3 conveys this part to a part's lower side dusting unit 11 to have its lower side to be cleared of dust by electrostatic dusting, blowing or otherwise.

A part with a protective sheet is carried to a protective sheet peeling unit before it is conveyed to the part's upper side dusting unit 10, where it is cleared of the protective sheet. There are usually two kinds of parts with protective sheets, which are the gasket and the MEA. The gasket usually has a protective sheet on only one side, while the MEA normally has protective sheets on both sides.

The gasket having a protective sheet on one side is conveyed to the gasket protective sheet peeling unit 7 and, after being cleared of the protective sheet, carried to the part's upper side dusting unit 10. The mechanism of the gasket protective sheet peeling unit 7 will be described afterwards.

The MEA having protective sheets on both sides is first conveyed to an MEA's upper protective sheet peeling unit 8 and, after being cleared of the upper protective sheet there, carried to an MEA's lower protective sheet peeling unit 9, where it is cleared of the lower protective sheet. After that, it is carried to the part's upper side dusting unit 10. The mechanism of the protective sheet peeling unit will be described afterwards.

After each part is dusted by the part's lower side dusting unit 11, the conveying robot 3 places it on an intermediate mount 12 in preparation for its handing over to the stacking robot 5. The stacking robot 5 picks up the part here, and carries it to a part's position adjusting unit 13, where it is subjected to optical apex detection and the adjustment of its orientation to figure out the central position. After that, the part is conveyed to a stacking position 14 and, with its central position being aligned, descended to be stacked on the preceding part.

After stacking all the parts by repeating this sequence of actions, the mount, which is in the lowest stacking position, is carried along the guide rail to a stack pressing unit 15, where it is pressed and fitted with fixing bolts. Then it is moved to a stack taking-out unit 16, where it is carried out of the stacking device.

In the whole device, a closed space is formed by device partitioning walls 17, and it is preferable to deliver clean air into the internal space to control its temperature and humidity and to minimize dust therein.

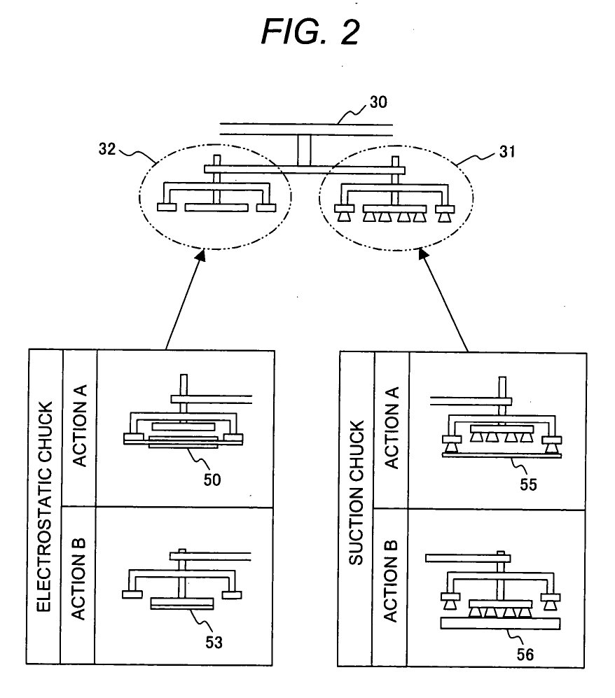

Each of the conveying robot 3 and the stacking robot 5 has a handling unit 30 for sucking parts. FIG. 2 illustrates the configuration of the mechanisms of the handling unit 30. This handling unit 30 comprises two kinds of mechanisms, of which one is a chuck 31 for thick and heavy parts and the other, a chuck 32 for thin and light parts. A vacuum suction chuck, which is stronger in sucking force, is used as the chuck 31 for thick and heavy parts, while an electrostatic chuck is used as the chuck 32 for thin and light parts, because a vacuum suction chuck would suck the part into the chuck to invite its deformation.

The thin and light parts include the MEA 50, the diffusion layers 53 and the gaskets 54 shown in FIG. 5. The diffusion layers are of the size corresponding to the electrodes 52 of the MEA 50, while the gaskets 54 are of the size corresponding to the exposed portion of the electrolyte membrane 51 of the MEA 50. To make the mechanism of the chuck 32 for thin and light parts with these different sizes, the chuck is double-structured. Thus, it chucks the MEA 50 and the gaskets 54 only with its outside portion as indicated by Action A of the electrostatic chuck shown in FIG. 2. On the other hand, it chucks the diffusion layers 53 only with its inside portion as indicated by Action B of the electrostatic chuck shown in FIG. 2.

The thick and heavy parts include the separators 55 and the terminal plates 56 shown in FIG. 5. In each separator 55, gas channels are formed inside, namely in the portions matching the diffusion layers, which forbid suction. Therefore, the outside gas sealing portions are sucked. This state is represented by Action A of the suction chuck shown in FIG. 2. On the other hand, the terminal plates, as they are usually heavy, may not ensure sufficient suction force with the outside gas sealing portions alone. Since the terminal plates are flat inside and relatively large in square measure, their whole inside portions are sucked. Action B of the suction chuck represents this state.

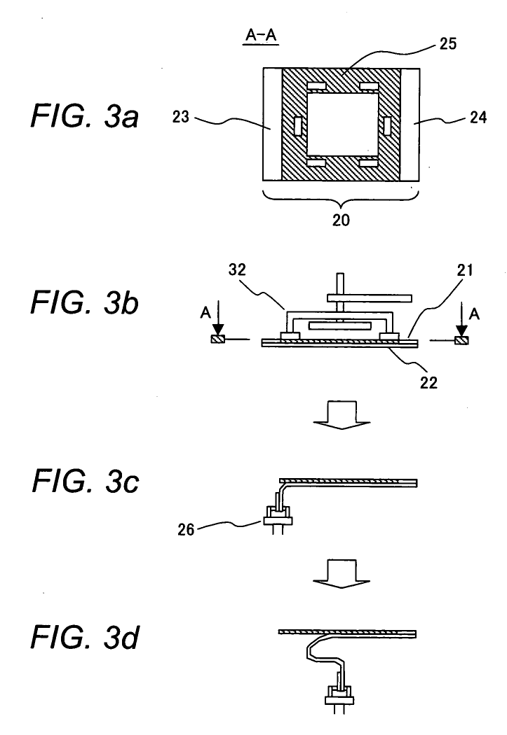

The gasket protective sheet peeling unit 7 peels off the protective sheet covering one face of the gasket. The mechanism of this action will be described. FIGS. 3A to 3D schematically show the mechanism of peeling the protective sheet off the gasket.

Referring to the plan of a gasket 20 shown in FIG. 3A, three regions including a gasket for actual use portion 25 to be stacked into a fuel cell, a pinching margin 23 to be held by a protective sheet chuck portion 26 and a warp prevention margin 24 are disposed on the gasket side. The protective sheet side 22 is a single-sheet item. The gasket for actual use portion 25 is sucked by the electrostatic chuck 32 and the protective sheet is peeled off, with the pinching margin 23 being held by the protective sheet chuck portion 26. Immediately before the end of the peeling action, the warp prevention margin 24 prevents the protective sheet from springing back, and the gasket for actual use portion 25, as shown in FIGS. 3B through 3D, can go through removal of the protective sheet while remaining in a state of being properly sucked by the electrostatic chuck 32. Without the warp prevention margin 24, the moment the peeling action ends, the protective sheet would spring back by its repulsive force to cause part of the gasket for actual use portion sucked by the electrostatic chuck 32 to be peeled off, and thereby invite its suction in a wavy state. Providing the warp prevention margin 24 is effective means for preventing this trouble.

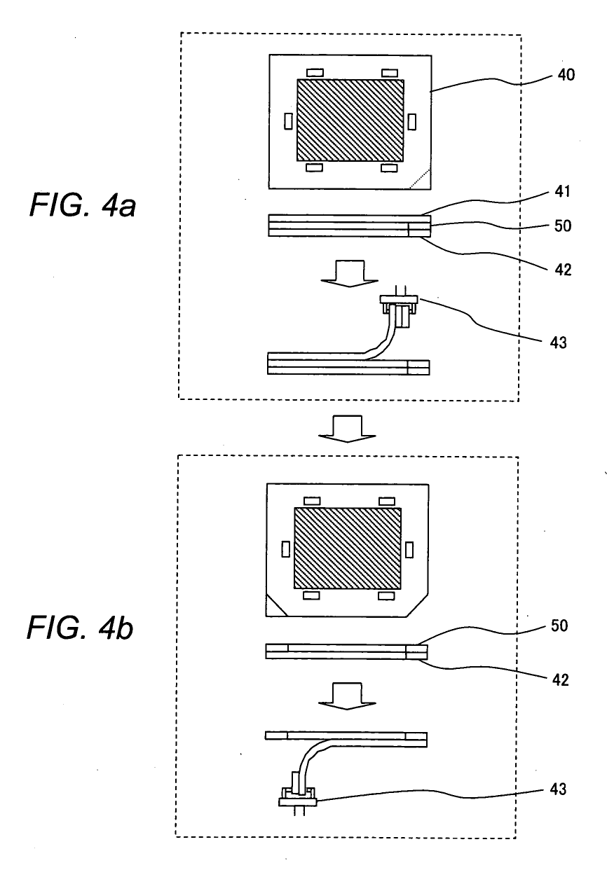

The mechanism of peeling off the protective sheets covering both faces of the MEA 50 will be described with reference to FIGS. 4A and 4B. Since the protective sheets of an MEA protective sheet-protected MEA 40 are thin and soft, they would exert no repulsive force unlike the gasket protective sheet. Therefore, no warp prevention margin 24, which is required by the gasket protective sheet, is needed. A small pinching margin would be satisfactory, and no pinching margin 23 for the gasket protective sheet is needed. Therefore, a cut is made into the terminal part to form a pinching margin.

First, a cut of a double thickness, namely as thick as a lower protective sheet 42 and the MEA together, is made into the terminal portion of to peel off an upper protective sheet 41 as shown in FIG. 4A. And a triple thickness of the terminal portion is held with a terminal chuck 43 and the upper protective sheet 41 is peeled off. Next, to peel off the lower protective sheet 42, a cut of a single thickness of the MEA 50 is made into the other terminal portion as shown in FIG. 4B, a double thickness of the terminal portion is held with the terminal chuck 43, and the lower protective sheet 42 is peeled off. In this way, both protective sheets can be peeled off the two-side protective sheet-protected MEA 40. Though a cut portion like a chamfer would remain at the terminal portion of the MEA 50, if it measures no more than a few mm, it will have no adverse effect on the performance of the fuel cell stack.

As described above, the cell stacking device according to the present invention has mechanisms for automatically assembling a fuel cell stack consisting of a variety of parts. Further to keep the assembling environment suitable for stacking, partitioning to surround the whole device is provided, and the temperature and humidity inside are controlled, with clean air introduced into the inner space. Moreover, to enable the speed of assembling to be increased, the speed of the robot carrying constituent parts is made variable according to the distance of conveyance, and further a stopper to prevent deviation can be provided to prevent the chucked part from coming off the chuck during acceleration or deceleration.

The present invention can be used as equipment for the mass production of fuel cell stacks. While there are many different types of fuel cells ranging from the normal temperature type to the high temperature type, the invention can be equally applied to any stack having a planar cell structure.

What is claimed is:

1. A fuel cell stacking method for conveying stack members to constitute a fuel cell stack and stacking them in a prescribed sequence; comprising the steps of:
moving each stack member to the prescribed stacking position thereof with a conveying robot;
detecting the positions or shapes of said stack members;
stacking the stack members in a prescribed sequence with a stacking robot on the basis of the detected information; and
fixing the stacked stack members.

2. The fuel cell stacking method according to claim 1, wherein the stack members are differentiated into large-number members and small-number members, and the differentiated groups are accommodated in trays for the large-number members and trays for the small-number members, respectively.

3. The fuel cell stacking method according to claim 1, further having a step of peeling protective sheets off the stack members.

4. The fuel cell stacking method according to claim 1, further having a step of dusting the stack members before the stacking step.

5. The fuel cell stacking method according to claim 1, wherein stacking positioning of the stack members and positional detection of each member after the stacking are accomplished by a laser system or an image sensing system.

6. The fuel cell stacking method according to claim 1, whereby the inside of the device is made a closed space and the closed space is filled with dust-free gas.

7. A fuel cell stacking device for conveying stack members to constitute a fuel cell stack and stacking them in a prescribed sequence, comprising a conveying robot, a stacking robot, a guide rail for enabling each robot to move to the stacking position along a prescribed route, a unit for detecting sides and/or apexes of said stack members, and a unit for aligning the positions of the stack members on the basis of the detected information.

8. The fuel cell stacking device according to claim 7, further having a conveyance zone comprising a region for supplying a group of small-number stack members and a region for supplying a group of large-number stack members, a stacking zone for stacking stack members, a protective sheet peeling-off zone provided between said supply regions and stacking zone, and a dusting zone before the stacking zone.

9. The fuel cell stacking device according to claim 7, wherein the stack members are differentiated into large-number members and small-number members, and the differentiated groups are accommodated in trays for the large-number members and trays for the small-number members, respectively.

10. The fuel cell stacking device according to claim 7, wherein the handling unit of said conveying robot has a handling subunit for lighter members and a handling subunit for heavier members or is disposed to be replaceable.

11. The fuel cell stacking device according to claim 7, having a plurality of conveying robots and stacking robots.

12. The fuel cell stacking device according to claim 7, wherein the member handling unit has a handling subunit for smaller members and a handling subunit for larger members or is disposed to be replaceable.

13. The fuel cell stacking device according to claim 7, wherein the handling subunit for lighter members is an electrostatic chuck and the handling subunit for heavier members is a suction chuck.

14. The fuel cell stacking device according to claim 7, further having a mechanism for peeling-off the protective sheets of the stack members.

15. The fuel cell stacking device according to claim 14, wherein said peeling-off mechanism is provided with a sub-mechanism for making a cut or cuts, each equal to the thickness of the protective sheet, into one or a plurality of corners of the stack members, a sub-mechanism for making a cut of a double thickness, namely the combined thickness of the member itself and a protective sheet on one side, or a sub-mechanism for making a cut equal to the thickness of the member itself alone.

16. The fuel cell stacking device according to claim 14, wherein the mechanism for peeling-off the protective sheets is disposed between the conveyance zone and the stacking zone.

17. The fuel cell stacking device according to claim 7, further comprising a mechanism which does not come into contact with the electrode portion of a membrane electrode assembly but chucks the electrolyte membrane around the electrode portion.

18. The fuel cell stacking device according to claim 7, further provided with a dusting unit for the stacking members disposed between the conveyance zone and the stacking zone.

19. The fuel cell stacking device according to claim 18, wherein the dusting mechanism is a unit which uses blowing of gas, suction or electrostatic force.

20. The fuel cell stacking device according to claim 7, further comprising a unit which positions members with the stacking robot and detects the position of each member after the stacking.

21. The fuel cell stacking device according to claim 20, wherein the unit for stacking positioning of the stack members and positional detection of each member after the stacking is a laser system or an image sensing system.

22. The fuel cell stacking device according to claim 6, wherein the inside of the device is made a closed space and the closed space is filled with dust-free gas.

23. The fuel cell stacking device according to claim 6, wherein the inside of the device is made a closed space, and a mechanism capable of adjusting the temperature and humidity in that closed space is provided.

24. The fuel cell stacking device according to claim 6, wherein the conveying robot and/or the stacking robot is equipped with mechanisms or a mechanism for adjusting the degree of acceleration/deceleration according to the length of the stroke of the shifting of the member.

25. The fuel cell stacking device according to claim 6, wherein the conveying robot and/or the stacking robot is equipped with stoppers or a stopper to prevent deviation of the member during the shifting of the conveying robot and/or the stacking robot.
